(19) United States
(12) Patent Application Publication
(10) Pub. No.: US 2009/0065548 A1
(43) Pub. Date: Mar. 12, 2009

(54) Stapling device

(76) Inventor: Chun Yuan Chang, Taipei (TW)

Correspondence Address: CHARLES E. BAXLEY, ESQUIRE, 90 JOHN STREET, SUITE 309, NEW YORK, NY, 10038, US

(21) Appl. No.: 12/286,268

(22) Filed: Sep. 29, 2008

Related U.S. Application Data
(63) Continuation-in-part of application No. 11/518,031, filed on Sep. 11, 2006.

(51) Int. Cl. B25C 5/02

(52) U.S. Cl. 227/120

(57) ABSTRACT

A stapling device includes a housing and a cover pivotally attached to a base member, a staple drive plate received in the housing for staple driving purpose, a spring device attached to the housing for biasing the staple drive plate, and a lever attached in the housing with the pivot pin having one end engageable with the spring device for moving the end portion of the spring device and the staple drive plate upwardly relative to the housing, and the lever is disengageable from the end portion of the spring device when the staple drive plate is moved to an upper portion of the passage of the housing and to be moved and driven by the spring device.

The present invention is a continuation-in-part of U.S. patent application Ser. No. 11/518,031, filed 11 Sep. 2006, pending.

### BACKGROUND OF THE INVENTION

1. Field of the Invention

The present invention relates to a stapling device, and more particularly to a stapling device including a staple drive plate having an increasing working strength for facilitating the working operation of the staple drive plate and for increasing the working life of the staple drive plate of the stapling device.

2. Description of the Prior Art

Various kinds of typical stapling devices have been developed and comprise a base member having an anvil plate, a staple magazine member and a driving member provided with a staple drive plate. A staple guide member and a staple feeder are coupled to the driving member, to feed the staples toward the driving member, and to allow the staples to be suitably driven or hammered by the driving member.

For example, U.S. Pat. No. 6,918,525 to Marks discloses one of the typical stapling devices comprising a multi function base provided with a sloped front, and the base surrounds the rear of the stapler body to provide a smooth exterior so that the device is natural to use both horizontally and vertically, a re-set spring provides a smooth re-set action as the handle is raised, and a staple striker includes three slots formed therein for engaging with a lever and two actuating ends of a larger staple pusher spring.

However, normally, the staple striker is required to be formed with the three slots therein for engaging with one end of the lever and two actuating ends of the larger staple pusher spring such that the working strength of the staple striker will be greatly decreased, and such that the working life of the staple striker will also be greatly decreased.

The applicant has developed the other typical stapling devices, such as U.S. Pat. No. 7,014,090 to Chang, and U.S. Pat. No. 7,240,819 to Chang, each of which also comprise a staple striker having three slots formed therein for engaging with a lever and two actuating ends of a larger staple pusher spring.

However, similarly, the staple striker is also required to be formed with the three slots therein for engaging with one end of the lever and two actuating ends of the larger staple pusher spring such that the working strength of the staple striker will also be greatly decreased, and such that the working life of the staple striker will also be greatly decreased.

The present invention has arisen to mitigate and/or obviate the afore-described disadvantages of the conventional staplers or stapling devices.

### SUMMARY OF THE INVENTION

The primary objective of the present invention is to provide a stapling device including a staple drive plate having an increasing working strength for facilitating the working operation of the staple drive plate and for increasing the working life of the staple drive plate of the stapling device.

The other objective of the present invention is to provide a stapling device including a staple pusher spring having an improved structure or a stronger structure for facilitating the working operation of the staple drive plate and for increasing the working life of the staple pusher spring.

In accordance with one aspect of the invention, there is provided a stapling device comprising a base member, a housing and a cover pivotally attached to the base member, and the housing including a passage formed therein, and including a pivot pin extended therein, a staple drive plate slidably received in the passage of the housing and movable relative to the housing for staple driving purpose, the staple drive plate including an orifice formed therein, a spring device attached to the housing and including an end portion engaged into the orifice of the staple drive plate for applying a spring biasing force to the staple drive plate, in order to bias and force the staple drive plate out through the passage of the housing and for staple driving purpose, and a lever slidably and pivotally attached in the housing with the pivot pin, and including a first end engaged with the cover, and including a second end engageable with the end portion of the spring device for selectively moving the end portion of the spring device and the staple drive plate upwardly relative to the housing when the first end of the lever is moved toward the housing by the cover, and the lever being movable away from the staple drive plate and disengageable from the end portion of the spring device when the end portion of the spring device is moved to an upper portion of the passage of the housing, for allowing the staple drive plate to be moved and driven by the spring device.

The housing includes a swelling extended therein and located below the pivot pin for forming a slot between the pivot pin and the swelling for engaging with the spring device and for securing the spring device to the housing.

The housing includes a retaining seat provided therein for engaging with the spring device and for securing the spring device to the housing. The lever includes an opening formed therein for engaging with the pivot pin and for slidably attaching the lever to the housing.

The spring device includes at least one ear extended from the end portion of the spring device for engaging with the second end of the lever. The lever includes at least one tongue extended from the second end of the lever for engaging with the ear of the spring device.

The spring device includes at least one protrusion extended from the spring device, and the lever includes at least one actuator extended therefrom for engaging with the protrusion of the spring device and for selectively moving the lever away from the staple drive plate.

The cover includes a block extended therein for engaging with the first end of the lever. The lever includes a space formed therein for receiving and positioning the end portion of the spring device.

The housing includes a spring member attached between the housing and the second end of the lever for biasing the second end of the lever downwardly relative to the housing and for moving the second end of the lever to engage with the end portion of the spring device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a stapling device in accordance with the present invention;

FIG. 2 is a perspective view of the stapling device, in which a portion of the stapling device has been cut off for showing an inner structure of the stapling device;

FIG. 3 is a partial side plan schematic view of the stapling device as shown in FIG. 2; and

FIGS. 4, 5 are partial side plan schematic views similar to FIG. 3, illustrating the operation of the stapling device.

### DETAILED DESCRIPTION OF THE PREFERRED EMBODIMENT

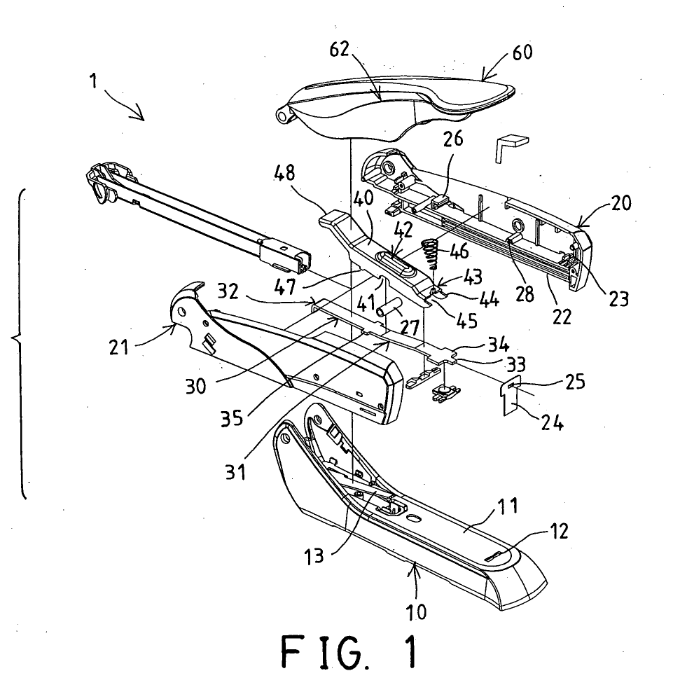

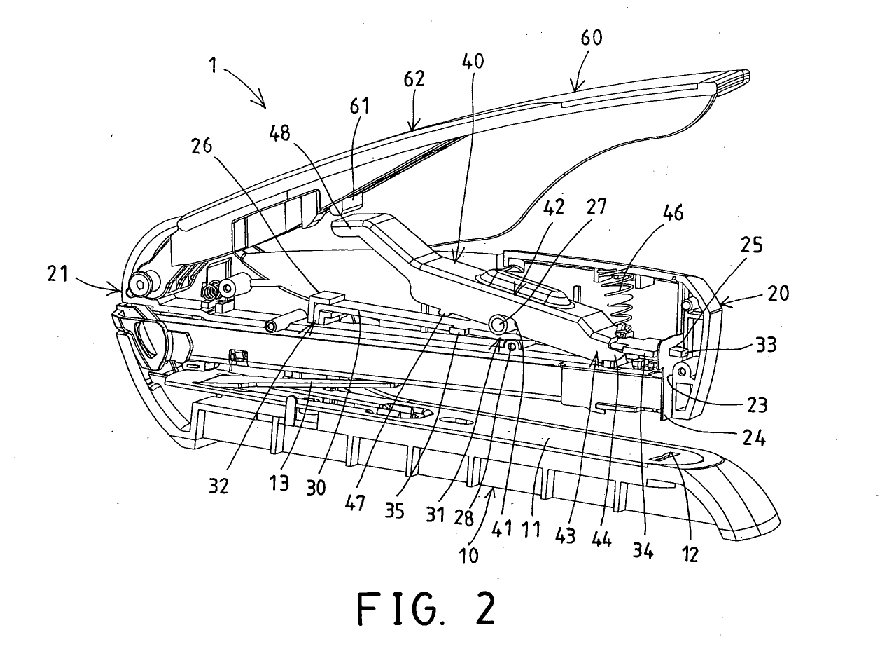

Referring to the drawings, and initially to FIGS. 1-3, a stapling device 1 in accordance with the present invention comprises a base member 10, an anvil plate 11 disposed in the upper portion of the base member 10 and having one or more inward staple guide depressions 12 formed in such as a front portion thereof, and having a spring arm 13 extended upward from the rear portion thereof (FIGS. 1 and 2). A staple magazine or housing 20 includes a rear portion 21 rotatably or pivotally attached or secured to the base member 10 for rotatably securing the housing 20 to the base member 10, and for allowing the housing 20 to be pivoted or rotated relative to the base member 10. The staple magazine or housing 20 may include two housing members secured together by fasteners, latches (not shown), adhesive materials, or by welding processes, or the like.

A handle or cover 60 is attached or secured to the housing 20 and/or rotatably or pivotally attached or secured to the base member 10 for allowing the cover 60 to be pivoted or rotated relative to the base member 10 and/or the housing 20. The pivotal coupling of the housing 20 and/or the cover 60 to the base member 10 is typical and will not be described in further details. The housing 20 includes a magazine member 22 formed or provided on the lower portion thereof for receiving the staples (not shown), and includes a passage 23 formed in the front portion thereof for slidably receiving a staple drive plate 24 therein, in which the staple drive plate 24 includes an orifice 25 formed therein. The housing 20 further includes an anchoring or retaining seat 26 provided therein, and includes a tubular or cylindrical pivot pin 27 laterally extended therein, and includes a swelling 28 extended or provided in the housing 20 and located below the pivot pin 27 for forming a gap or slot 29 between the pivot pin 27 and the swelling 28 or below the pivot pin 27 or in the housing 20.

A staple pusher spring or spring blade or spring device 30 is attached or anchored or secured to the housing 20, for example, the spring device 30 includes a middle portion 31 engaged into or through the slot 29 that is formed between the pivot pin 27 and the swelling 28 of the housing 20, and includes one end or rear end 32 attached or anchored or secured to the housing 20, such as attached to the retaining seat 26 of the housing 20, and includes the other end or front end portion 33 engaged into or through the orifice 25 of the staple drive plate 24 for selectively biasing or forcing the staple drive plate 24 to push or strike or drive the staples. The spring device 30 further includes one or more (such as two) ears 34 laterally and oppositely extended from the other end or front end portion 33 of the spring device 30, and one or more (such as two) protrusions 35 laterally and oppositely extended from the middle portion 31 of the spring device 30.

An actuating means or device 4 includes a lever 40 having an oblong opening 41 formed in the middle portion 42 thereof for slidably and rotatably or pivotally receiving the pivot pin 27 and for slidably and rotatably or pivotally attaching or securing the lever 40 in the housing 20 with the pivot pin 27, in which the oblong opening 41 of the lever 40 includes a width or length greater than the outer diameter of the pivot pin 27 for allowing the lever 40 to slightly slide relative to the housing 20 and the pivot pin 27. The lever 40 includes a front end 43 engageable with the ears 34 of the spring device 30 and disengageable from the ears 34 of the spring device 30. For example, the lever 40 includes two tongues 44 formed or extended or provided on the front end 43 thereof for selectively engaging with the ears 34 of the spring device 30, and includes a space 45 formed between the tongues 44 for stably receiving and anchoring or positioning the front end portion 33 of the spring device 30.

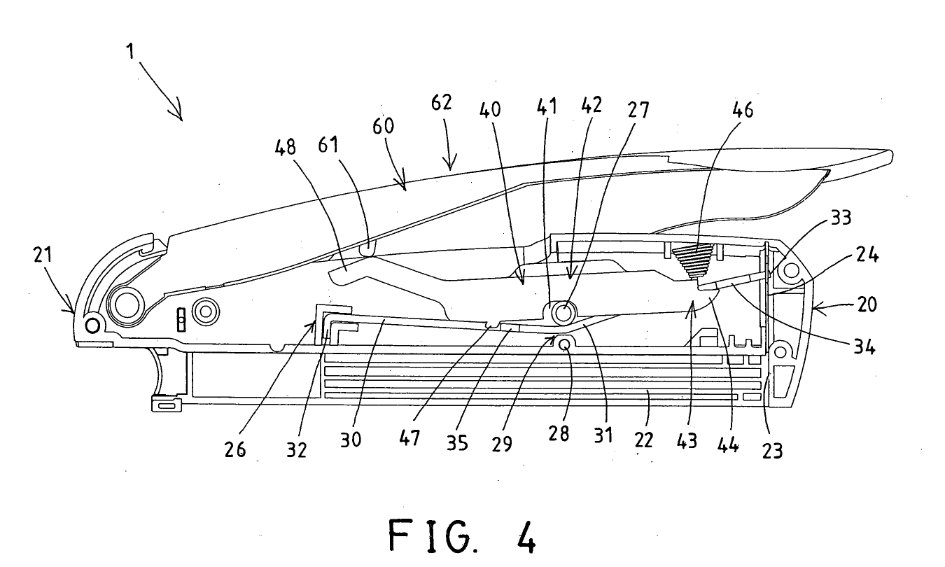

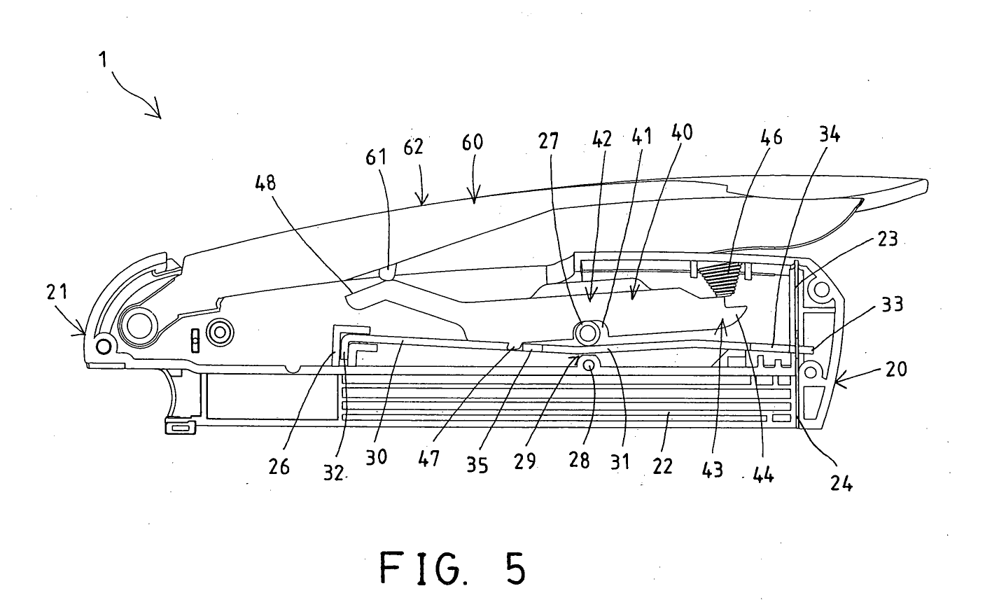

The tongues 44 or the front end 43 of the lever 40 may be engaged with the front end portion 33 or the ears 34 of the spring device 30 when the lever 40 is moved forwardly relative to the housing 20 (FIGS. 2-4) for selectively moving or elevating the front end portion 33 of the spring device 30 and the staple drive plate 24 upwardly (FIG. 4), and the tongues 44 or the front end 43 of the lever 40 may be arranged to be disengaged from the front end portion 33 or the ears 34 of the spring device 30 (FIG. 5) when the lever 40 is moved rearwardly relative to the housing 20, for allowing the staple drive plate 24 to be moved or forced downwardly and/or outwardly through the passage 23 of the housing 20 in order to push or strike or drive the staples. The forward and the rearward sliding movements of the lever 40 relative to the housing 20 may be limited by the sliding engagement of the pivot pin 27 in the oblong opening 41 of the lever 40.

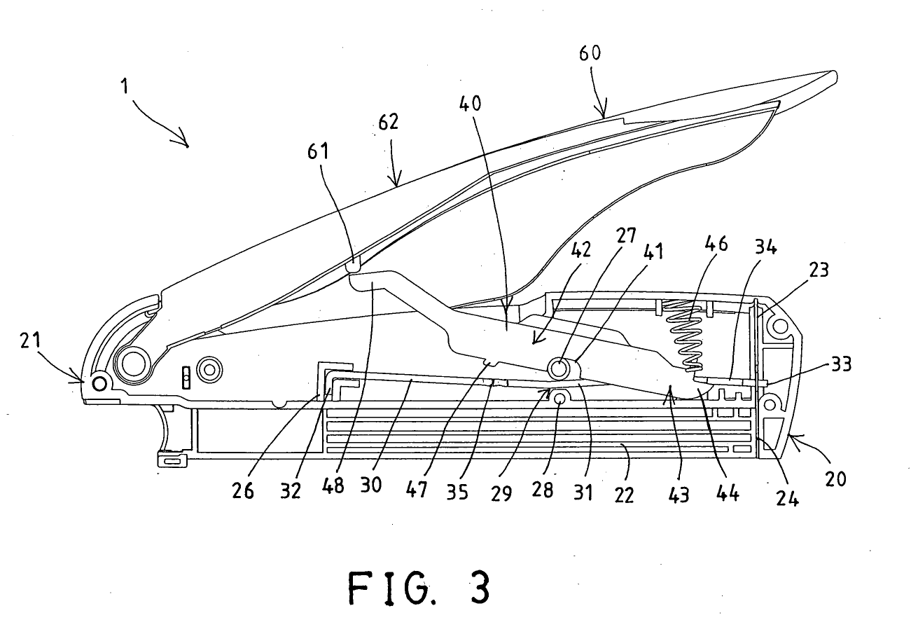

A spring member 46 may be attached or engaged between the housing 20 and the front end 43 of the lever 40 for biasing or forcing or moving the front end 43 of the lever 40 downwardly relative to the housing 20 and for allowing the tongues 44 or the front end 43 of the lever 40 to be moved to engage with the front end portion 33 or the ears 34 of the spring device 30 again (FIG. 3). The lever 40 further includes one or more (such as two) fingers or actuators 47 extended downwardly from the middle portion 42 of the lever 40 for selectively engaging with the protrusions 35 of the spring device 30 (FIGS. 4, 5) and for selectively moving the lever 40 rearwardly relative to the housing 20 or the spring device 30, and thus for selectively disengaging the tongues 44 or the front end 43 of the lever 40 from the front end portion 33 or the ears 34 of the spring device 30, and thus for allowing the staple drive plate 24 to be moved or forced to push or strike or drive the staples by the spring device 30.

It is preferable that the cover 60 includes a block 61 extended or provided in the middle portion 62 thereof, and the lever 40 includes a rear end 48 slidably engaged with the block 61 of the cover 60 for allowing the lever 40 to be rotated or pivoted relative to the housing 20 by the cover 60 when the cover 60 is depressed or moved toward or relative to the housing 20, and thus for allowing the tongues 44 or the front end 43 of the lever 40 to be moved or rotated upwardly relative to the housing 20 in order to push or move or elevate the front end portion 33 of the spring device 30 and the staple drive plate 24 upwardly relative to the housing 20. The actuators 47 of the lever 40 are arranged to be engaged with the protrusions 35 of the spring device 30 to move the lever 40 rearwardly relative to the housing 20 or the spring device 30, and to disengage the tongues 44 or the front end 43 of the lever 40 from the front end portion 33 or the ears 34 of the spring device 30 when the front end portion 33 of the spring device 30 is moved to the upper portion of the passage 23 of the housing 20.

In operation, as shown in FIGS. 2 and 3, when the cover 60 has not been depressed by the user, the front end 43 of the lever 40 may be moved or forced downwardly relative to the housing 20 and the tongues 44 or the front end 43 of the lever 40 may be moved to engage with the front end portion 33 or the ears 34 of the spring device 30 by the spring member 46. As shown in FIG. 4, when the cover 60 is depressed or rotated downwardly relative to or toward the housing 20, the front end portion 33 of the spring device 30 and the staple drive plate 24 may be moved upwardly by the tongues 44 or the front end 43 of the lever 40. When the cover 60 is further depressed or rotated downwardly relative to or toward the housing 20, the actuators 47 of the lever 40 may be moved or forced to engage with the protrusions 35 of the spring device 30 and to move the lever 40 rearwardly relative to the housing 20 or the spring device 30 or away from the staple drive plate 24, and to disengage the tongues 44 or the front end 43 of the lever 40 from the front end portion 33 or the ears 34 of the spring device 30 and thus for allowing the staple drive plate 24 to be moved or forced to push or strike or drive the staples by the spring device 30.

When the cover 60 is released, the spring member 46 may bias and rotate the lever 40 clockwise relative to the housing 20 and the cover 60, to bias and force the cover 60 to move or rotate away from the housing 20 and to the original or normal position ready for staple driving operation. The spring arm 13 of the base member 10 may be used to bias the housing 20 upwardly away from the base member 10 to the original or normal position. It is to be noted that the staple drive plate 24 includes only one orifice 25 formed therein such that the strength of the staple drive plate 24 will not be decreased, and such that the working life of the staple drive plate 24 will not be decreased. In addition, the staple pusher spring or the spring device 30 includes a stronger structure for effectively driving the staple drive plate 24 and for increasing the working life of the staple pusher spring or the spring device 30.

Accordingly, the stapling device in accordance with the present invention includes a staple drive plate having an increasing working strength for facilitating the working operation of the staple drive plate and for increasing the working life of the staple drive plate of the stapling device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A stapling device comprising:
a base member,
a housing and a cover pivotally attached to said base member, and said housing including a passage formed therein, and including a pivot pin extended therein,
a staple drive plate slidably received in said passage of said housing and movable relative to said housing for staple driving purpose, said staple drive plate including an orifice formed therein,
a spring device attached to said housing and including an end portion engaged into said orifice of said staple drive plate for applying a spring biasing force to said staple drive plate, in order to bias and force said staple drive plate out through said passage of said housing and for staple driving purpose, and
a lever slidably and pivotally attached in said housing with said pivot pin, and including a first end engaged with said cover, and including a second end engageable with said end portion of said spring device for selectively moving said end portion of said spring device and said staple drive plate upwardly relative to said housing when said first end of said lever is moved toward said housing by said cover, and said lever being movable away from said staple drive plate and disengageable from said end portion of said spring device when said end portion of said spring device is moved to an upper portion of said passage of said housing, for allowing said staple drive plate to be moved and driven by said spring device.

2. The stapling device as claimed in claim 1, wherein said housing includes a swelling extended therein and located below said pivot pin for forming a slot between said pivot pin and said swelling for engaging with said spring device and for securing said spring device to said housing.

3. The stapling device as claimed in claim 1, wherein said housing includes a retaining seat provided therein for engaging with said spring device and for securing said spring device to said housing.

4. The stapling device as claimed in claim 1, wherein said lever includes an opening formed therein for engaging with said pivot pin and for slidably attaching said lever to said housing.

5. The stapling device as claimed in claim 1, wherein said spring device includes at least one ear extended from said end portion of said spring device for engaging with said second end of said lever.

6. The stapling device as claimed in claim 5, wherein said lever includes at least one tongue extended from said second end of said lever for engaging with said at least one ear of said spring device.

7. The stapling device as claimed in claim 1, wherein said spring device includes at least one protrusion extended from said spring device, and said lever includes at least one actuator extended therefrom for engaging with said at least one protrusion of said spring device and for selectively moving said lever away from said staple drive plate.

8. The stapling device as claimed in claim 1, wherein said cover includes a block extended therein for engaging with said first end of said lever.

9. The stapling device as claimed in claim 1, wherein said lever includes a space formed therein for receiving and positioning said end portion of said spring device.

10. The stapling device as claimed in claim 1, wherein said housing includes a spring member attached between said housing and said second end of said lever for biasing said second end of said lever downwardly relative to said housing and for moving said second end of said lever to engage with said end portion of said spring device.
